(19) United States
(12) Patent Application Publication
(10) Pub. No.: US 2015/0089421 A1
(43) Pub. Date: Mar. 26, 2015

(54) INFORMATION PROCESSING DEVICE, INFORMATION PROCESSING DEVICE CONTROL METHOD, AND RECORDING MEDIUM

(71) Applicant: SHARP KABUSHIKI KAISHA, Osaka-shi, Osaka (JP)

(72) Inventors: Miho Kagei, Osaka-shi (JP); Fumitoshi Tanoue, Osaka-shi (JP); Toshiyuki Kamei, Osaka-shi (JP)

(73) Assignee: SHARP KABUSHIKI KAISHA, Osaka-shi, Osaka (JP)

(21) Appl. No.: 14/399,828

(22) PCT Filed: May 10, 2013
(86) PCT No.: PCT/JP2013/063200

§ 371 Date: Nov. 7, 2014

(30) Foreign Application Priority Data
May 11, 2012 (JP) 2012-110046

(51) Int. Cl. G06F 3/0484; G06F 3/0488; G06F 3/0481

(52) U.S. Cl. CPC G06F 3/04845; G06F 3/04817; G06F 3/0488
USPC 715/769

(57) ABSTRACT

A smart phone (100) is configured so that, in a case where a first display position of an icon (6) is changed, a condition determining section (11) determines whether or not an icon other than the icon (6) is being displayed within a predetermined region that includes a second display position of the icon (6) to which second display position the first display position of the icon (6) has been changed, and in a case where the condition determining section (11) determines that the icon other than the icon (6) is not being displayed within the predetermined region, a partition line display section (12a) causes a partition line (1) to be displayed between the second display position of the icon (6) and a display position of another icon other than the icon (6).

### TECHNICAL FIELD

The present invention relates to, for example, an information processing apparatus which (i) has an input surface capable of detecting a position specified by a user's operation, and a display surface capable of displaying a plurality of icons and (ii) is capable of changing a display position of an icon on the display surface in accordance with a specified position.

### BACKGROUND ART

An electronic device having a display screen provided with a touch panel has been in widespread use. An opportunity that a user carries out a touch operation on the electronic device has increased. A user can give an input to an electronic device, such as some home-use video game machines or an information terminal typified by a so-called smart phone, by selecting an “icon” which represents, by a graphic or symbol, for example, (i) a program (application) executed by the electronic device or (ii) data used in executing a process of the program.

This allows a user to intuitively and easily give an input as compared to a conventional method of giving an input by user's operating an input device such as a keyboard. The electronic device is designed so that a user can carry out many operations by selecting icons.

Under these circumstances, an attempt to improve how to display icons has been frequently made. For example, Patent Literature 1 discloses a display control technique which allows a user to recognize a specific partition which partitions items listed on a screen which is being scrolled and to confirm an item located at an end part.

### CITATION LIST

### Patent Literature

Patent Literature 1

Japanese Patent Application Publication, Tokukai, No. 2012-27797 (Publication Date: Feb. 9, 2012)

### SUMMARY OF INVENTION

### Technical Problem

The number of icons to be displayed on a display screen of an electronic device tends to increase as the number of applications etc. to be installed on the electronic device increases. Therefore, a technique for arranging and displaying a plurality of icons is required. It is, however, not preferable to arrange the icons by carrying out a complicated operation. This is because, for example, a mobile information terminal such as a smart phone has a display screen whose size is limited.

Patent Literature 1 does not disclose a technique which meets the requirement. That is, the display control technique disclosed in Patent Literature 1 is a mere technique which allows a user to recognize a specific partition which partitions listed items while the user is scrolling a screen, but does not focus on “arranging icons”.

The present invention was made in view of the problem, and an object of the present invention is to provide, for example, an information processing apparatus capable of classifying, through a simple operation, icons displayed on a display screen.

### Solution to Problem

In order to attain the object, an information processing apparatus of an aspect of the present invention is configured to be an information processing apparatus including: an input surface capable of detecting a position specified by a user's operation; a display surface capable of displaying a plurality of icons; a determination section for determining whether or not a predetermined condition is met; and a classification section for, in a case where the determination section determines that the predetermined condition is met, classifying the plurality of icons, display positions of the plurality of icons on the display surface being changeable in accordance with the position specified by the user's operation, in a case where a first display position of an icon of the plurality of icons is changed, the determination section determining whether or not another icon other than the icon of the plurality of icons is being displayed within a predetermined region that includes a second display position of the icon to which second display position the first display position of the icon has been changed, and in a case where the determination section determines that the another icon is not being displayed within the predetermined region, the classification section causing a partition line to be displayed between the second display position of the icon and a display position of another icon of the plurality of icons.

In order to attain the object, a method, of the aspect of the present invention, of controlling an information processing apparatus is configured to be a method of controlling an information processing apparatus capable of changing, in accordance with a position specified by a user's operation, display positions of a plurality of icons on a display surface capable of displaying the plurality of icons, the method including the steps of: (a) determining whether or not a predetermined condition is met; and (b), in a case where it is determined in the step (a) that the predetermined condition is met, classifying the plurality of icons, in a case where a first display position of an icon of the plurality of icons is changed, it being determined in the step (a) whether or not another icon other than the icon of the plurality of icons is being displayed within a predetermined region that includes a second display position of the icon to which second display position the first display position of the icon has been changed, and in a case where it is determined in the step (a) that the another icon is not being displayed within the predetermined region, in the step (b), a partition line being caused to be displayed between the second display position of the icon and a display position of another icon of the plurality of icons.

### Advantageous Effects of Invention

According to the aspect of the present invention, the information processing apparatus of and the method of controlling the information processing apparatus of the present invention bring about an effect that it is possible to classify icons displayed on a display screen through a user's simple operation for changing a display position of an icon.

### BRIEF DESCRIPTION OF DRAWINGS

FIG. 1 is a block diagram illustrating a main configuration of a smart phone of an embodiment of the present invention.

(a) of FIG. 2 is a view schematically illustrating an example appearance of the smart phone. (b) of FIG. 2 is a view schematically illustrating an example operation of the smart phone carried out by a user.

FIG. 3 is a view schematically illustrating an example of a screen which the smart phone displays on a display surface.

FIG. 4 is a view schematically illustrating an example arrangement of icons in a case where the smart phone displays the icons on the display surface.

FIG. 5 is a view schematically illustrating a first example operation of the smart phone in a case where a user carries out an operation for shifting an icon to a position in a third row of a first column. (a) of FIG. 5 illustrates an example screen before the user carries out the operation. (b) of FIG. 5 illustrates an example screen on which the user is carrying out the operation. (c) of FIG. 5 illustrates an example screen immediately after the user carries out the operation. (d) of FIG. 5 illustrates an example screen on which the shifting of the icon is completed.

FIG. 6 is a view schematically illustrating a second example operation of the smart phone in a case where a user carries out an operation for shifting an icon to a position in a third row of a second column. (a) of FIG. 6 illustrates an example screen before the user carries out the operation. (b) of FIG. 6 illustrates an example screen on which the user is carrying out the operation. (c) of FIG. 6 illustrates an example screen immediately after the user carries out the operation. (d) of FIG. 6 illustrates an example screen on which the shifting of the icon is completed.

FIG. 7 is a view schematically illustrating a positional relation between a region α or a region β and a center of an icon whose display position is to be changed by a user (an icon which is being shifted). (a) of FIG. 7 illustrates a case where the center of the icon which is being shifted is present in the region α. (b) of FIG. 7 illustrates a case where the center of the icon whose display position is to be changed by the user is present in the region β.

FIG. 8 is a view schematically illustrating a third example operation of the smart phone in a case where a user carries out an operation for shifting an icon to a position in a third row of a second column. (a) of FIG. 8 illustrates an example screen before the user carries out the operation. (b) of FIG. 8 illustrates an example screen on which the user is carrying out the operation. (c) of FIG. 8 illustrates an example screen immediately after the user carries out the operation. (d) of FIG. 8 illustrates an example screen on which the shifting of the icon is completed.

FIG. 9 is a view schematically illustrating a fourth example operation of the smart phone in a case where a user carries out an operation for shifting an icon to a position in a first row of a second column. (a) of FIG. 9 illustrates an example screen before the user carries out the operation. (b) of FIG. 9 illustrates an example screen on which the user is carrying out the operation. (c) of FIG. 9 illustrates an example screen immediately after the user carries out the operation. (d) of FIG. 9 illustrates an example screen on which the shifting of the icon is completed.

FIG. 10 is a view schematically illustrating a fifth example operation of the smart phone in a case where a user carries out a pinch-in operation with respect to a partition line. (a) of FIG. 10 illustrates an example screen on which the user is carrying out the pinch-in operation with respect to the partition line. (b) of FIG. 10 illustrates an example screen immediately after the partition line is undisplayed due to the pinch-in operation. (c) of FIG. 10 illustrates an example screen after an icon is advanced to a position at which an icon is more preferentially displayed because the position becomes vacant.

FIG. 11 is a view schematically illustrating a sixth example operation of the smart phone in a case where a user carries out a pinch-out operation within a predetermined region which does not include a partition line sandwiched by display positions of at least two icons. (a) of FIG. 11 illustrates an example screen on which the user is carrying out the pinch-out operation within the predetermined region. (b) of FIG. 11 illustrates an example screen immediately after a partition line is newly displayed due to the pinch-out operation.

FIG. 12 is a flowchart illustrating an example of processes carried out by the smart phone.

FIG. 13 is a flowchart illustrating an example of another processes carried out by the smart phone.

### DESCRIPTION OF EMBODIMENTS

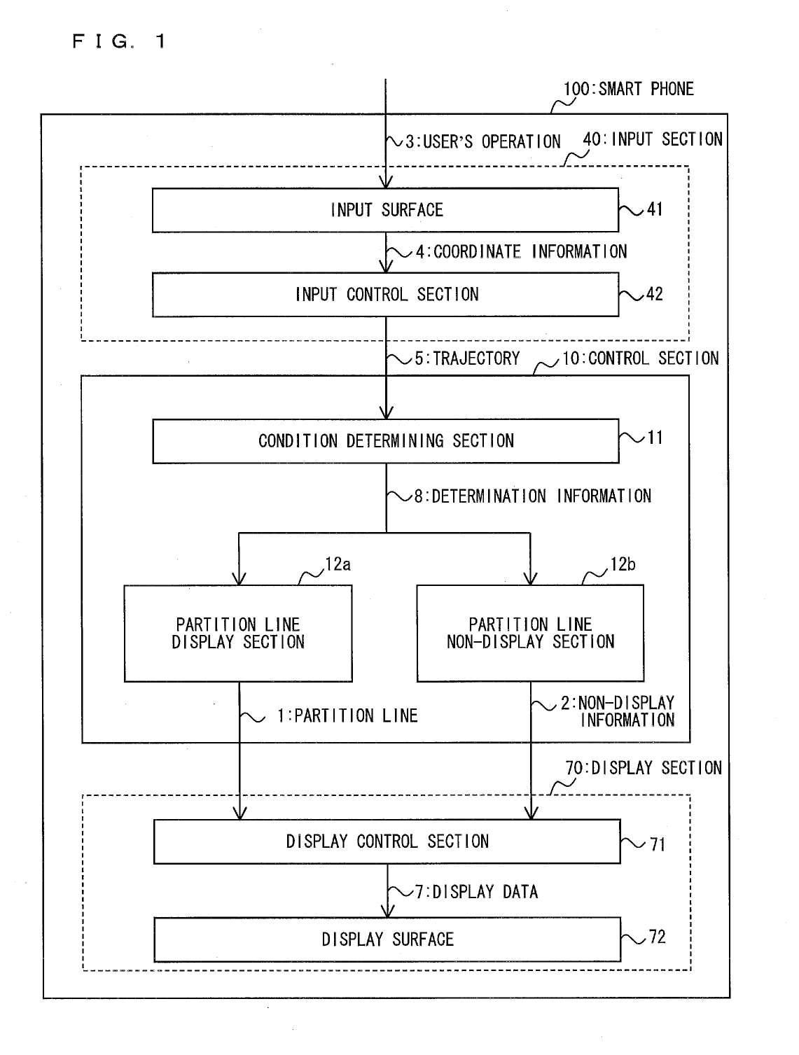

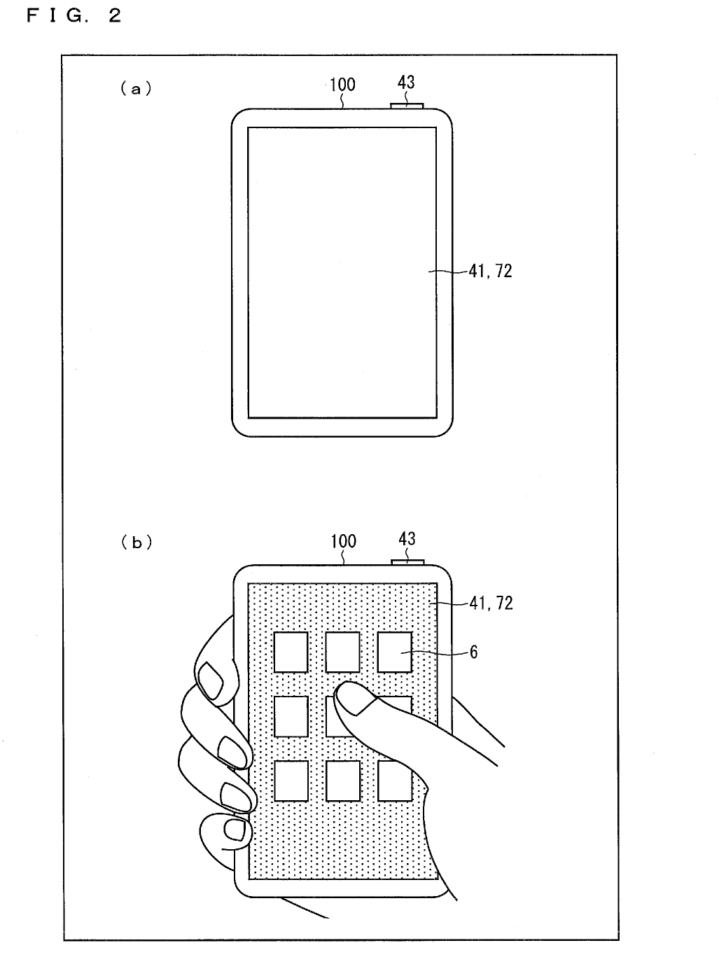

The following description will discuss in detail an embodiment of the present invention with reference to FIGS. 1 through 13.

In order to clarify that a member includes a plurality of members, “a”, “b”, “c”, “d” or “e” will be further added to a reference numeral of the member which reference number is identical to those of the plurality of members. For example, a plurality of icons are shown as “icon 6a”, “icon 6b”, “icon 6c”, “icon 6d”, and “icon 6e”.

The symbols a, b, c, d, and e which are further added to the reference numeral of member will be sometimes omitted, and the plurality of members will be generally called. For example, the icon 6a, the icon 6b, the icon 6c, the icon 6d, the icon 6e, and a given combination thereof are generally called “icon 6”.

Note that the following description and the drawings will explain the embodiment of the present invention on an assumption of a case where a user holds a smart phone 100 (see FIG. 1) with his/her right hand and touches an input surface with a thumb of the right hand (see, for example, FIG. 2). Note, however, that the smart phone 100 may be held and operated by a right hand or a left hand, and the input surface may be touched by a finger other than a thumb.

A user can operate the smart phone 100 not with his/her finger but with a tool such as a stylus. That is, the term “user's finger” (later described) includes the meaning “the tool such as the stylus”. Note, however, that, for simplicity of description, “user's finger” and “the tool such as the stylus” are hereinafter referred to simply as “user's finger”.

The following description and the drawings will further explain the embodiment of the present invention on an assumption of a case where “a user touches the input surface with his/her finger” (touch operation). Note, however, that, in a case where an input surface 41 (see FIG. 1) is, for example, a touch panel capable of detecting approach of a user's finger, the smart phone 100 is operable by detecting the approach of the user's finger to the input surface 41 in the same manner as by being touched.

[Outline of Smart Phone 100]

An outline of the smart phone 100 will be described below with reference to FIG. 1. FIG. 1 is a block diagram illustrating a main configuration of the smart phone 100.

The smart phone 100 (information processing apparatus) has (i) the input surface 41 capable of detecting a position specified by a user's operation and (ii) a display surface 72 capable of displaying a plurality of icons 6. The smart phone 100 can change a display position of an icon 6 on the display surface 72 in accordance with a specified position.

An example appearance of and an example operation of the smart phone 100 will be described below with reference to FIG. 2. (a) of FIG. 2 is a view schematically illustrating the example appearance of the smart phone 100. (b) of FIG. 2 is a view schematically illustrating the example operation of the smart phone 100 carried out by a user.

As illustrated in (a) of FIG. 2, the smart phone 100 is provided with a power supply switch 43 in addition to the input surface 41 and the display surface 72. In order to clarify a function of each of the input surface 41 and the display surface 72, FIG. 1 illustrates the input surface 41 and the display surface 72 separately.

However, for example, in a case where the input surface 41 and the display surface 72 are realized by a touch panel and a liquid crystal display, respectively, the input surface 41 and the display surface 72 may be integrated with each other (see (a) of FIG. 2). With this configuration, a touch position at which a finger of a user touches the input surface 41 is identical to a display position at which the display surface 72 displays a graphic etc. in accordance with the touch. This allows the user to gain a sense of naturally giving an input to the input surface 41.

A user can give the smart phone 100 information on, for example, selection of an icon 6, by touching the input surface 41 to specify a position on the input surface 41 to the smart phone 100 of (to give the smart phone 100 a coordinate on the input surface 41) (see (b) of FIG. 2).

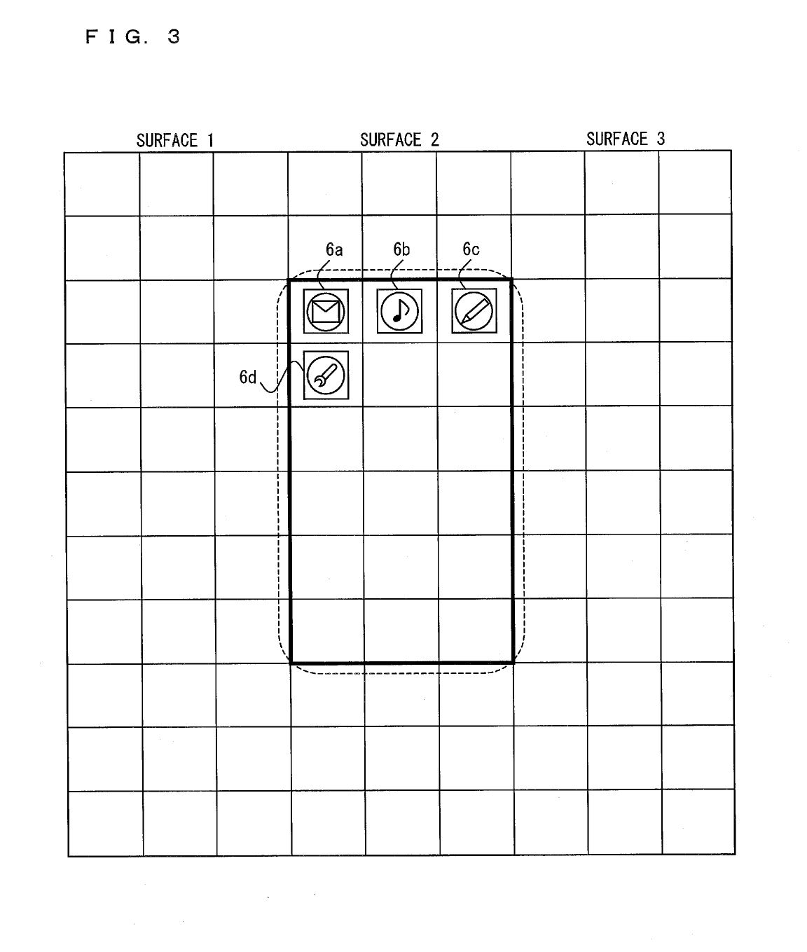

An example screen displayed by the smart phone 100 will be described below with reference to FIG. 3. FIG. 3 is a view schematically illustrating an example of a screen which the smart phone 100 displays on the display surface 72. Note that FIG. 3 has a lattice pattern illustrated so as to clarify a relation between display positions of respective icons. Note, however, that the smart phone 100 does not necessarily display the lattice pattern on the display surface 72 (the same applies to drawings which will be referred to below).

The smart phone 100 displays an icon 6 in each of compartments arranged in a lattice manner of M rows and N columns (six rows and three columns in an example illustrated in FIG. 3). The compartments virtually extend beyond a region displayable on the display surface 72 of the smart phone 100 (a part enclosed by a dotted line in FIG. 3). A user can change a displayed region by carrying out a predetermined operation with respect to the smart phone 100.

Note here that the predetermined operation may be an operation for quickly flipping the input surface 41 (a so-called flick operation) or an operation for pressing a predetermined operation key. In a case where the smart phone 100 is provided with an acceleration sensor, the predetermined operation may be an operation for giving the smart phone 100 a shake (a so-called shaking operation). In a case where the smart phone 100 is provided with means for recognizing audio, the predetermined operation may be an operation for giving the smart phone 100 audio indicative of a user's instruction.

The displayed region can be changed by a given amount to a given direction. For example, a user can change a partitioned display of an n column(s) (three columns in the example illustrated in FIG. 3) by carrying out a rightward or leftward flick operation with respect to the input surface 41 (that is, the user can change an icon display of three columns by carrying out a single operation). Alternatively, a user can scroll an icon display on a same display screen by carrying out an upward or downward flick operation with respect to the input surface 41.

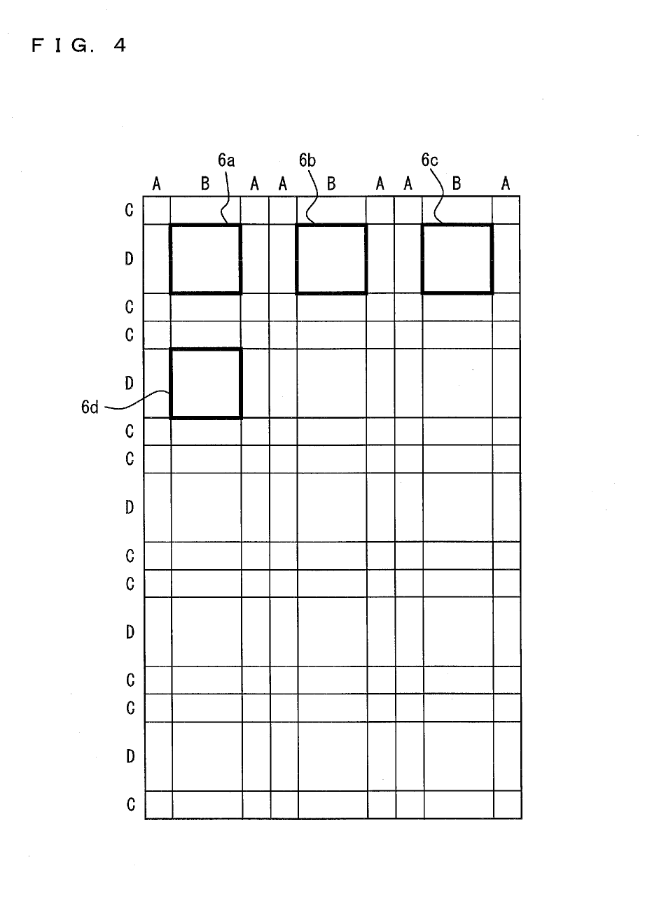

An example arrangement of icons 6 on the screen will be described below with reference to FIG. 4. FIG. 4 is a view schematically illustrating the example arrangement of the icons 6 in a case where the smart phone 100 displays the icons 6 on the display surface 72. In FIG. 4, symbols A through D each represent a width of a compartment corresponding to the each of the symbols A through D. Note that a unit of the width is not limited to a specific one, and therefore may be, for example, dot, pixel, point, or centimeter.

According to the present embodiment, each icon 6 has a size of D in a longitudinal direction and B in a traverse direction (see FIG. 4). In a case where the smart phone 100 detects a user's touch operation in a rectangular region of D+2×C in the longitudinal direction and B+2×A in the traverse direction which rectangular region includes a display position of an icon 6 in a center of the rectangular region, the smart phone 100 determines that the user has selected the icon 6 as a target icon to be operated. The rectangular region may be hereinafter referred to as a “determination region”.

The smart phone 100 displays an icon 6a so that an upper left corner of the icon 6a is present at a position (i) downward by C from an upper end of a display screen and (ii) rightward by A from a left end of the display screen. Similarly, the smart phone 100 arranges and displays an icon 6b so that an upper left corner of the icon 6b is present at a position (i) downward by C from the upper end of the display screen and (ii) rightward by B+3×A from the left end of the display screen. The smart phone 100 also displays an icon 6d so that an upper left corner of the icon 6d is present at a position (i) downward by D+3×C from the upper end of the display screen and (ii) rightward by A from the left end of the display screen.

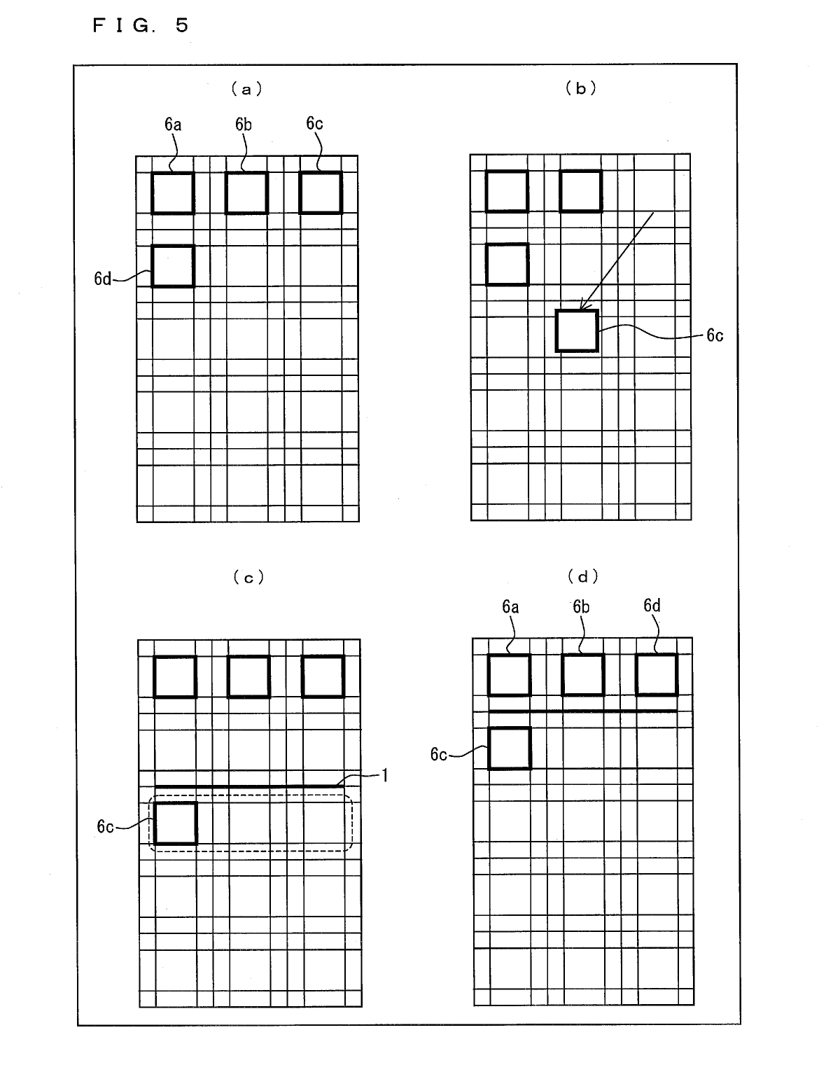

A basic operation of the smart phone 100 will be described below with reference to FIG. 5. FIG. 5 is a view schematically illustrating a first example operation of the smart phone 100 in a case where a user carries out an operation for shifting an icon 6c to a position in a third row of a first column.

(a) of FIG. 5 illustrates an example screen before the user carries out the operation. (b) of FIG. 5 illustrates an example screen on which the user is carrying out the operation. Note that (b) of FIG. 5 illustrates an arrow so as to clarify a shift direction of the icon 6c. Note, however, that the smart phone 100 does not necessarily display the arrow on the display surface 72 (the same applies to drawings which will be referred to below). (c) of FIG. 5 illustrates an example screen immediately after the user carries out the operation. (d) of FIG. 5 illustrates an example screen on which the shifting of the icon 6c is completed.

As illustrated in (a) through (d) of FIG. 5, a user can shift the icon 6c by carrying out an operation for touching a determination region of the icon 6c on the input surface 41 with a finger of the user and sliding the finger on the input surface 41 while the finger is in touch with the input surface 41 (a so-called drag operation). When the user leaves the finger from the input surface 41 (a so-called icon drop), a position where the finger is left is a display position of the icon 6c. That is, (a) through (d) of FIG. 5 illustrate a successive flow of a display screen on which the user carries out a so-called drag and drop operation to change the display position of the icon 6c from a position in the first row of the third column to a position in a second row of a first column.

Note that, during a user's operation for shifting an icon 6, the smart phone 100 may display no icon other than the icon 6 or may transparently display an icon(s) other than the icon 6. This allows the smart phone 100 to clearly display, for a user, an icon 6 which the user is shifting.

Further, during the user's operation, the smart phone 100 may display a dotted frame of the icon 6 at an original display position of the icon 6. This allows the smart phone 100 to clearly display, for the user, a position from which the icon 6 is shifted.

As illustrated in (b) and (c) of FIG. 5, in a case where no icon other than the icon 6c is displayed within a predetermined region that includes the position of the icon 6c to which position the icon 6C is shifted (e.g., a row or column to which the icon 6c is shifted; in a dotted rectangle in an example illustrated in (c) of FIG. 5), the smart phone 100 displays a partition line 1 between display positions of icons other than the icon 6c and the position of the icon 6c to which position the icon 6C is shifted.

As such, the smart phone 100 can classify icons 6 to be displayed on the display screen, in response to a user's simple operation for changing a display position of an icon 6.

As illustrated in (b) and (c) of FIG. 5, in a case where a position where an icon is more preferentially displayed becomes vacant due to the user's operation for shifting the icon 6c, the smart phone 100 advances, to the position where the icon is more preferentially displayed, the icon 6d displayed at a low-priority position so as to display the icon 6d at the position where the icon is more preferentially displayed.

It should be noted here that, according to the present embodiment, priority of display of icons in respective compartments is determined so that (i) a highest priority is given to a compartment of an upper left corner and (ii) the priority is lowered toward a compartment of a lower right corner. This allows the smart phone 100 to display icons 6 with an effective utilization of the display screen.

As illustrated in (c) and (d) of FIG. 5, in a case where there is a row (or a column) where no icon 6 is arranged, the smart phone 100 overall changes a display position of an icon so that the row (or the column) is eliminated.

[Configuration of Smart Phone 100]

The configuration of the smart phone 100 will be described below with reference to FIG. 1. Note that, for simplicity of description, description of a configuration of a part that does not have a direct relation with the present embodiment is omitted, and the part is not illustrated in the block diagram of FIG. 1. Note, however, that the smart phone 100 may include such an omitted configuration according to a circumstance where the present invention is put into practice.

The following description will discuss functions borne by (i) an input section 40 (the input surface 41 and an input control section 42), (ii) a control section 10 (a condition determining section 11, a partition line display section 12a, and a partition line non-display section 12b), and (iii) a display section 70 (a display control section 71 and the display surface 72) in this order.

The input section 40 receives an operation from a user (a user's operation 3). The input section 40 includes the input surface 41 and the input control section 42.

The input surface 41 supplies, to the input control section 42, two-dimensional coordinate information 4 of a user's finger which is in touch with the input surface 41. The input surface 41 of the present embodiment is desirably a multi-touch detectable touch panel. Note, however, that kinds of hardware are not limited to a touch panel provided that the input surface 41 is an input device capable of detecting a touch position through a user's operation.

The input control section 42 detects a trajectory 5 of the user's operation 3 on the input surface 41. For example, the input control section 42 obtains the two-dimensional coordinate information 4 from the input surface 41 at predetermined time intervals, and supplies a series of pieces of coordinate data as the trajectory 5 to the condition determining section 11.

The control section 10 controls various functions of the smart phone 100 in an integrated manner. Each function of the control section 10 may be realized by a CPU (Central Processing Unit) executing a program stored in a storage element such as a RAM (Random Access Memory) or a flash memory. The control section 10 includes the condition determining section 11, the partition line display section 12a, and the partition line non-display section 12b.

The control section 10 determines whether or not an icon 6 is being dragged. In a case where the control section 10 determines that an icon 6 is being dragged, the control section 10 temporarily shifts the icon 6 in accordance with the drag. The control section 10 further determines whether or not the icon 6 has been dropped. In a case where the control section 10 determines that the icon 6 has been dropped, the control section 10 changes a display position of the icon 6 to a position where the icon 6 has been dropped.

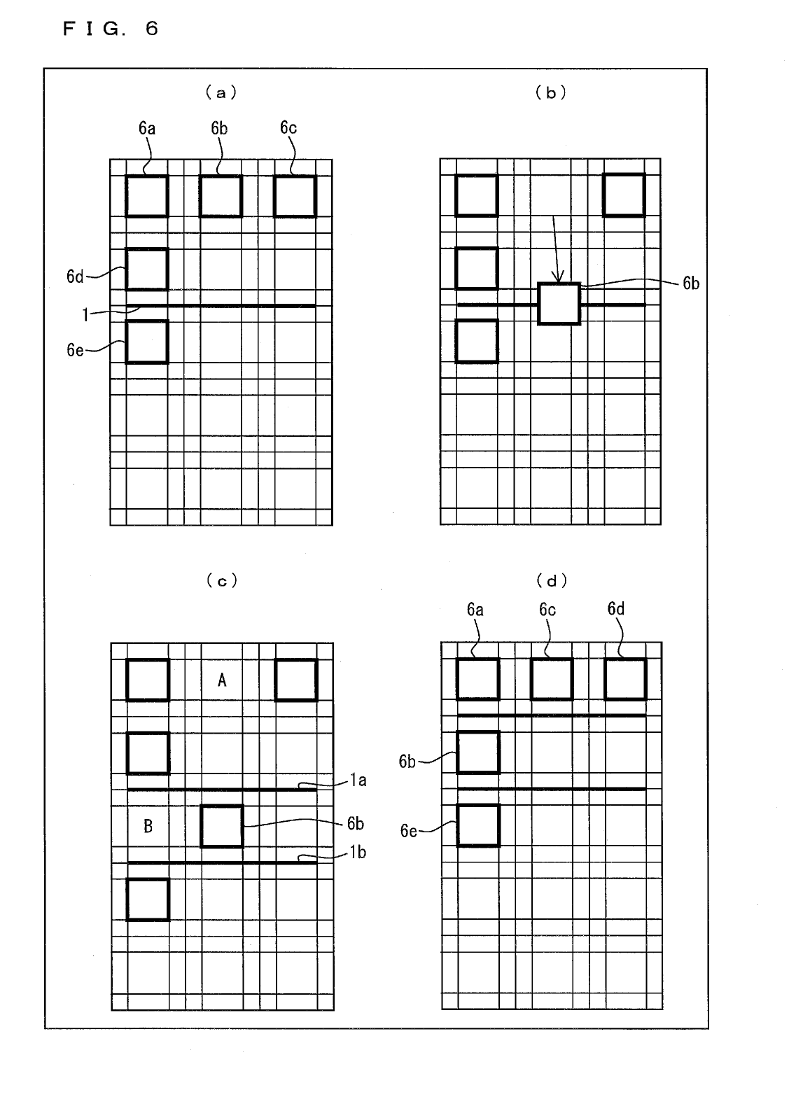

The control section 10 shifts an icon displayed below a partition line (e.g., an icon 6e on a screen illustrated in (b) of FIG. 6) and the partition line, downward by one row from a display position of the icon. The control section 10 further arranges a display position of an icon. That is, in a case where a position where an icon is more preferentially displayed becomes vacant due to a user's operation for shifting an icon, the control section 10 advances, to the position where the icon is more preferentially displayed, an icon displayed at a low-priority position, so that the icon displayed at the low-priority position is displayed at the position where the icon is more preferentially displayed.

In a case where a first display position of an icon 6 is changed, the condition determining section 11 (determination section) determines whether or not an icon other than the icon 6 is being displayed within a predetermined region that includes a second display position of the icon 6 to which second display position the first display position of the icon 6 has been changed.

Specifically, by receiving a trajectory 5 from the input control section 42, the condition determining section 11 obtains a display position of an icon 6 (i) to which display position the icon 6 has been shifted and (ii) which display position is indicated by the trajectory 5 (e.g., final coordinate information 4 which constitutes the trajectory 5). The condition determining section 11 then determines whether or not an icon other than the icon 6 is being displayed within a predetermined region that includes the display position of the icon 6 to which display position the icon 6 has been shifted (e.g., in a row or column to which the icon 6 has been shifted). The condition determining section 11 further supplies, to the partition line display section 12a and the partition line non-display section 12b, determination information 8 indicative of a determination result.

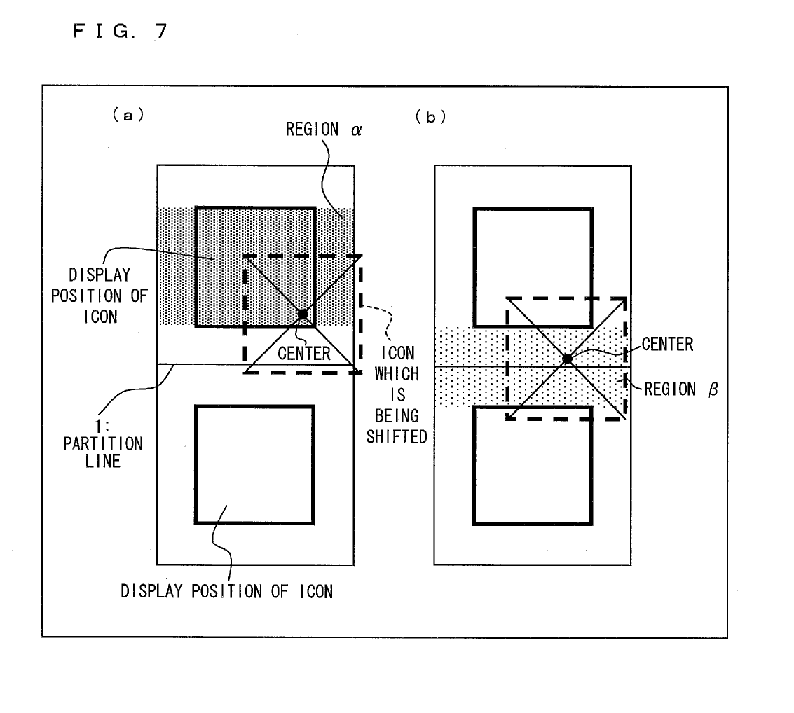

The condition determining section 11 further determines whether or not a first display position of an icon 6 has been changed so that the icon 6 overlaps with a partition line 1. That is, when the condition determining section 11 obtains a second display position of an icon 6 to which second display position the icon 6 has been shifted in the same manner as described above, the condition determining section 11 determines whether or not the second display position of the icon 6 overlaps with a partition line 1 (whether or not an icon and a partition line are in a display state illustrated in (b) of FIG. 6 (later described)). The condition determining section 11 then supplies, to the partition line display section 12a, determination information 8 indicative of a determination result. Note that a concrete determination process will be later described in detail with reference to FIG. 7.

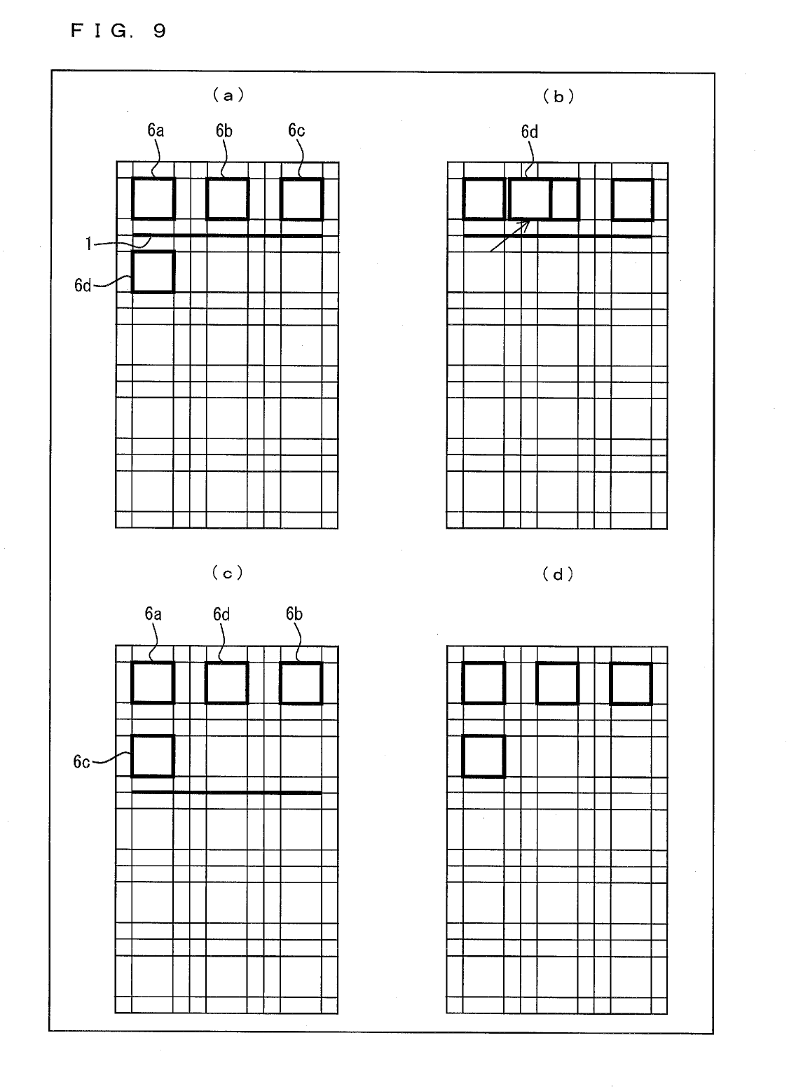

In a case where a display position of an icon 6 is changed, the condition determining section 11 further determines whether or not a partition line 1 is being displayed between display positions of at least two icons. In other words, the condition determining section 11 determines whether or not the partition line 1 is sandwiched by the at least two icons (whether or not a partition line and icons are in a display state illustrated in (c) of FIG. 9 (later described)). The condition determining section 11 then supplies, to the partition line non-display section 12b, determination information 8 indicative of a determination result.

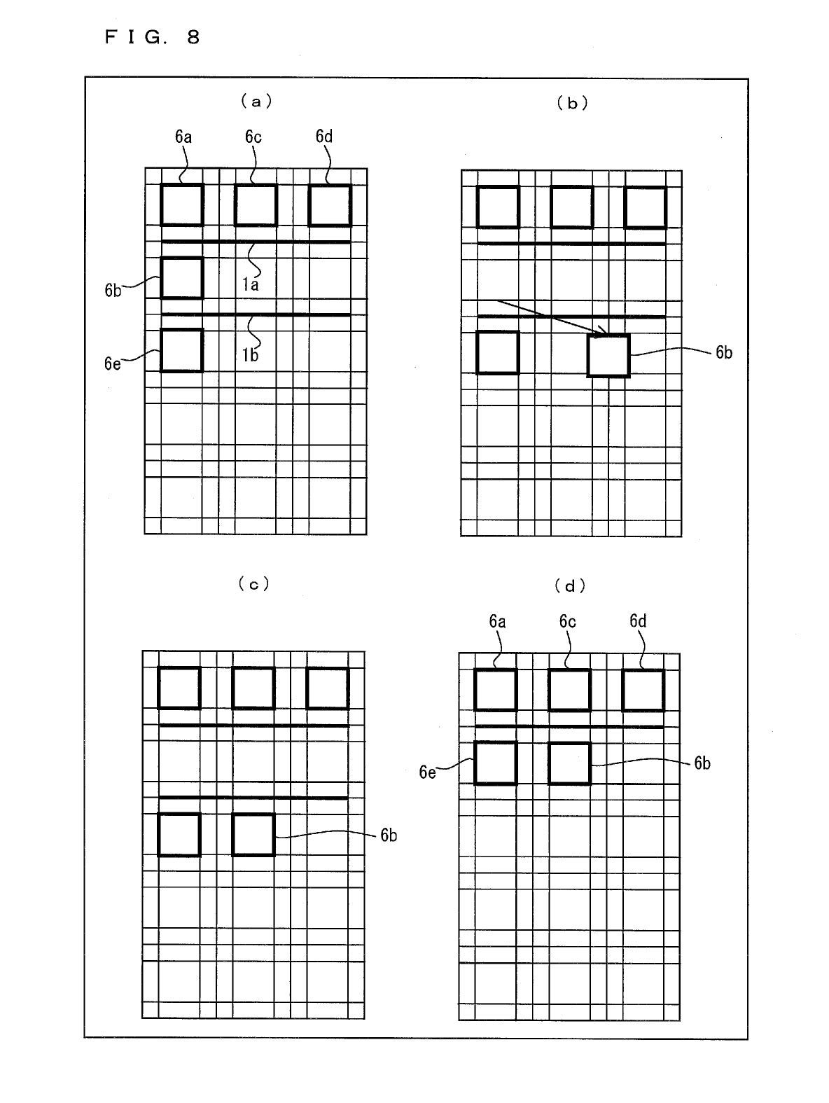

In a case where a first display position of an icon 6 is changed, the condition determining section 11 further determines whether or not a plurality of partition lines 1 are being consecutively displayed between a display position of an icon other than the icon 6 and a second display position of the icon 6 to which second display position the first display position of the icon 6 has been changed. In other words, the condition determining section 11 determines whether or not at least one icon 6 is present between two partition lines 1 (whether or not icons and partition lines are in a display state illustrated in (c) of FIG. 8 (later described)). The condition determining section 11 then supplies, to the partition line non-display section 12b, determination information 8 indicative of a determination result.

In a case where a display position of an icon 6 is not changed, the condition determining section 11 determines whether or not a user has carried out, with respect to a partition line 1, a pinch-in operation for moving a plurality of fingers toward a given point present between the plurality of fingers so as to join the plurality of fingers while the plurality of fingers are in touch with the input surface 41 (while a plurality of positions are being specified). The condition determining section 11 then supplies, to the partition line non-display section 12b, determination information 8 indicative of a determination result.

In a case where a display position of an icon is not changed, the condition determining section 11 further determines whether or not a user has carried out, within a predetermined region that does not include a partition line sandwiched by display positions of at least two icons, a pinch-out operation for moving a plurality of fingers from a given point present between the plurality of fingers so as to extend a space between the plurality of fingers while the plurality of fingers are in touch with the input surface 41 (while a plurality of positions are being specified). The condition determining section 11 then supplies, to the partition line non-display section 12b, determination information 8 indicative of a determination result.

In a case where the condition determining section 11 determines that an icon other than an icon 6 is not being displayed, the partition line display section 12a (classification section) causes a partition line 1 to be displayed between a display position of the icon 6 and a display position of another icon other than the icon 6.

Specifically, when the partition line display section 12a receives, from the condition determining section 11, determination information 8 indicative of a determination result that the icon other than the icon 6 is not being displayed, the partition line display section 12a notifies the display control section 71 that the partition line 1 which partitions the another icon other than the icon 6 from the icon 6 whose display position has been changed is to be displayed.

In a case where the condition determining section 11 determines that a first display position of an icon 6 has been changed so that the icon 6 overlaps with a partition line 1, the partition line display section 12a can cause partition lines 1 to be displayed on respective opposite sides of the icon 6. Specifically, when the partition line display section 12a receives, from the condition determining section 11, determination information 8 indicative of a determination result that a second display position of the icon 6 to which second display position the first display position of the icon 6 has been changed overlaps with the partition line 1, the partition line display section 12a notifies the display control section 71 that the partition lines 1 is to be displayed on the respective of the icon 6 (see (c) of FIG. 6 (later described)).

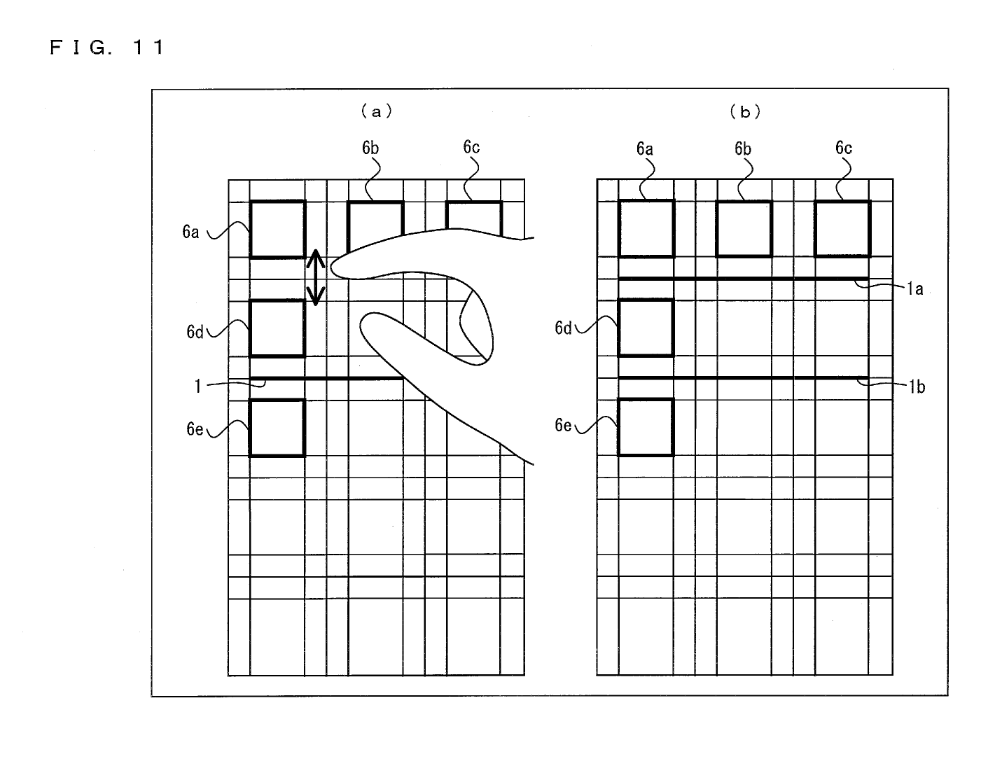

In a case where the condition determining section 11 determines that a pinch-out operation has been carried out, the partition line display section 12a can cause a partition line to be displayed within a predetermined region that does not include a partition line sandwiched by display positions of at least two icons. Specifically, when the partition line display section 12a receives, from the condition determining section 11, determination information 8 showing that the pinch-out operation has been carried out, the partition line display section 12a notifies the display control section 71 that a partition line 1 is to be displayed (see (a) and (b) of FIG. 11 (later described)).

In a case where a partition line 1 is displayed not to be sandwiched between display positions of at least two icons 6 due to a change in display position of an icon 6, the partition line non-display section 12b (a first non-display section, second non-display section, or third non-display section) causes the partition line 1 to be undisplayed.

That is, when the partition line non-display section 12b receives, from the condition determining section 11, determination information 8 indicative of a determination result that a partition line 1 is not sandwiched by at least two icons (a determination result that icons and a partition line are in a display state illustrated in (c) of FIG. 9 (later described)), the partition line non-display section 12b supplies, to the display control section 71, non-display information 2 for causing the partition line 1 which is unnecessary to be undisplayed.

In a case where the condition determining section 11 determines that a plurality of partition lines 1 are being consecutively displayed, the partition line non-display section 12b causes at least one of the plurality of partition lines 1 to be undisplayed so that only one of the plurality of partition lines 1 is displayed. In other words, in the case where the condition determining section 11 determines that the plurality of partition lines 1 are being consecutively displayed, the partition line non-display section 12b causes a partition line(s), other than the only one partition line 1, of the plurality of partition lines 1 to be undisplayed so that the only one partition line 1 is displayed.

That is, when the partition line non-display section 12b receives, from the condition determining section 11, determination information 8 indicative of a determination result that no icon 6 is present between two partition lines 1 (a determination result that icons and partition lines are in a display state illustrated in (c) of FIG. 8 (later described)), the partition line non-display section 12b supplies, to the display control section 71, non-display information 2 for causing an unnecessary partition line 1 of the two partition lines 1 to be undisplayed.

In a case where the condition determining section 11 determines that a pinch-in operation has been carried out with respect to a partition line, the partition line non-display section 12b causes the partition line to be undisplayed. Specifically, when the partition line non-display section 12b receives, from the condition determining section 11, determination information 8 showing that the pinch-in operation has been carried out with respect to the partition line, the partition line non-display section 12b supplies, to the display control section 71, non-display information 2 for causing the partition line to be undisplayed.

The display section 70 displays, for a user, a result of a process carried out in the control section 10 (a partition line 1 or non-display information 2). The display section 70 includes the display control section 71 and the display surface 72.

The display control section 71 supplies display data 7 to the display surface 72 so that an icon 6 or a partition line 1 can be displayed on the display surface 72. The display data 7 may be, for example, a bit-mapped image, an image based on another format, or an image based on a data format suitable for another display. Note that the display control section 71 is not limited to a specific one provided that the display control section 71 includes a format converter for converting content to be displayed into a format of display data 7. An example of the display control section 71 is a typical display adapter.

The display surface 72 is a device for displaying the display data 7 supplied from the display control section 71. The present embodiment mainly assumes a case where the display surface 72 is a liquid crystal display (LCD). However, kinds of hardware are not limited provided that the display surface 72 is a device having a display function (particularly, a flat panel display). The display surface 72 may be a device such as a device which includes (i) a display element such as a plasma display panel (PDP) or an EL (Electroluminescence) display and (ii) a driver circuit for driving the display element in accordance with display data 7 supplied from the display control section 71.

As has been described, in a case where the input surface 41 and the display surface 72 are realized by a touch panel and a liquid crystal display, respectively, the input surface 41 and the display surface 72 may be integrated with each other. In this case, the input surface 41 may be constituted by a transparent member (such as glass) having a rectangular plate-like shape, and integrated with the display surface 72 so as to cover the display surface 72.

[Details of Operation of Smart Phone 100 in Response to User's Operation for Shifting Icon]

A second example operation of the smart phone 100 will be described with reference to FIG. 6. FIG. 6 is a view schematically illustrating the second example operation of the smart phone 100 in a case where a user carries out an operation for shifting an icon 6b to a position in a third row of a second column.

(a) of FIG. 6 illustrates an example screen before the user carries out the operation. (b) of FIG. 6 illustrates an example screen on which the user is carrying out the operation. (c) of FIG. 6 illustrates an example screen immediately after the user carries out the operation. (d) of FIG. 6 illustrates an example screen on which the shifting of the icon 6b is completed. That is, (a) through (d) of FIG. 6 illustrate a successive flow of a display screen on which the user operates the icon 6b which is present at a position in a first row of the second column to change a display position of the icon 6b from the position in the first row of the second column to the position in the third row of the second column.

The condition determining section 11 finds that a user has changed the display position of the icon 6b so that the icon 6b overlaps with a partition line (see (b) of FIG. 6). In a case where the condition determining section 11 finds so, the partition line display section 12a causes partition lines to be displayed on respective opposite sides of the icon 6b (see (c) of FIG. 6).

That is, the smart phone 100 shifts an icon 6e displayed below a partition line 1 and the partition line 1, downward by one row from a display position of the icon 6e. The partition line display section 12a then causes a partition line 1a to be additionally displayed. The display position of the icon 6b is changed to a position between the added partition line 1a and a partition line 1b (the partition line 1) which is shifted downward at which position the icon 6b has been dropped. As such, in a case where a user drops the icon 6b on the partition line 1, the partition line 1a and the partition line 1b are displayed so as to sandwich the icon 6b.

As has been described, in a case where a position where an icon is more preferentially displayed becomes vacant due to a user's operation for shifting a first icon 6, the smart phone 100 advances, to the position where the icon is more preferentially displayed, a second icon 6 displayed at a low-priority position so as to display the second icon 6 at the position where the icon is more preferentially displayed.

Therefore, in a case where a position (see part A in (c) of FIG. 6) higher in priority than display positions of respective icons 6c and 6d is vacant (see (c) of FIG. 6), the smart phone 100 displays the icon 6c at the part A and displays the icon 6d at the display position of the icon 6c (see (d) of FIG. 6). This causes a state where no icon is arranged in a second row. The smart phone 100 changes the display positions of the respective icons 6b and 6e so that the second row is eliminated.

Similarly, in a case where a position (see part B in (c) of FIG. 6) higher in priority than the display position of the icon 6b is vacant (see (c) of FIG. 6), the smart phone 100 advances the icon 6b to the part B so as to display the icon 6b at the part B (see (d) of FIG. 6).

The following description will discuss, with reference to FIG. 7, a concrete process carried out by the smart phone 100 in a case where the condition determining section 11 determines whether or not a display position of an icon 6 to which display position the icon 6 has been shifted overlaps with a partition line 1. FIG. 7 is a view schematically illustrating a positional relation between a region α or a region β and a center of an icon 6 whose display position is to be changed by a user (an icon which is being shifted). (a) of FIG. 7 illustrates a case where the center of the icon 6 whose display position is to be changed by the user (the icon which is being shifted) is present in the region α. (b) of FIG. 7 illustrates a case where the center of the icon 6 whose display position is to be changed by the user is present in the region β.

In the case where, as illustrated in (a) of FIG. 7, the center of the icon 6 which is being shifted is included in the region α (in a predetermined region including a display position of an icon other than the icon 6 which is being shifted), the condition determining section 11 determines that the icon 6 does not overlap with a partition line 1. In a case where the condition determining section 11 determines so, the smart phone 100 changes the display position of the icon 6 to the display position of the icon 6 to which display position the icon 6 has been shifted.

In the case where, as illustrated in (b) of FIG. 7, the center of the icon 6 which is being shifted is included in the region β (in a predetermined region sandwiched by display positions of at least two icons other than the icon 6 which is being shifted), the condition determining section 11 determines that the icon 6 overlaps with the partition line 1. In a case where the condition determining section 11 determines so, the partition line display section 12a causes partition lines 1 to be displayed on respective opposite sides of the icon 6 (see (c) of FIG. 6).

That is, the condition determining section 11 (determination section) determines whether or not the display position of the icon 6 has been changed so that the icon 6 overlaps with the partition line 1, on the basis of a positional relation between (i) the center of the icon 6 whose display position has been changed and (ii) the predetermined region including the display position of the icon other than the icon 6 or the predetermined region sandwiched by the display positions of the at least two icons other than the icon 6.

The above has described a case where the condition determining section 11 makes a determination on the basis of the positional relation between the center of the icon 6 which is being shifted and the region α or the region β. The determination may be made on the basis of a positional relation between the region α or the region β and a center of a finger which is in touch with the input surface 41.

The region α may be a region of a display position of an icon (a region of D in a longitudinal direction and B in a traverse direction (see FIG. 4)) or an external region including the region (a rectangular region of D+2×C in the longitudinal direction and B+2×A in the traverse direction, i.e., the above-described determination region (see FIG. 4)).

A range of the region β is arbitrarily adjustable. That is, the region β may be separated by a predetermined distance (e.g., 10 pixels) from an end part of a display position of an icon (in (b) of FIG. 7, a lower side of an upper icon displayed or an upper side of a lower icon displayed).

A third example operation of the smart phone 100 will be described with reference to FIG. 8. FIG. 8 is a view schematically illustrating the third example operation of the smart phone 100 in a case where a user carries out an operation for shifting an icon 6b to a position in a third row of a second column.

(a) of FIG. 8 illustrates an example screen before the user carries out the operation. (b) of FIG. 8 illustrates an example screen on which the user is carrying out the operation. (c) of FIG. 8 illustrates an example screen immediately after the user carries out the operation. (d) of FIG. 8 illustrates an example screen on which the shifting of the icon 6b is completed. That is, (a) through (d) of FIG. 8 illustrate a successive flow of a display screen on which the user operates the icon 6b which is present at a position in a second row of a first column to change a display position of the icon 6b from the position in the second row of the first column to the position in the third row of the second column.

The condition determining section 11 finds that, as illustrated in (b) and (c) of FIG. 8, a plurality of partition lines (partition lines 1a and 1b) are being consecutively displayed between the display position of the icon 6b and display positions of another icons (icons 6a, 6c, and 6d) (no icon is present between the partition lines 1a and 1b). In a case where the condition determining section 11 finds so, the partition line non-display section 12b causes at least one of the plurality of partition lines (either one of the partition lines 1a and 1b) to be undisplayed so that only one of the plurality of partition lines is displayed (see (d) of FIG. 8).

As a result of the user's operation for shifting the icon 6b, no icon is present in the second row. Therefore, as has been described, the smart phone 100 changes the display position of the icon 6b and a display position of an icon 6e so that the second row is eliminated.

A fourth example operation of the smart phone 100 will be described with reference to FIG. 9. FIG. 9 is a view schematically illustrating the fourth example operation of the smart phone 100 in a case where a user carries out an operation for shifting an icon 6d to a position in a first row of a second column.

(a) of FIG. 9 illustrates an example screen before the user carries out the operation. (b) of FIG. 9 illustrates an example screen on which the user is carrying out the operation. (c) of FIG. 9 illustrates an example screen immediately after the user carries out the operation. (d) of FIG. 9 illustrates an example screen on which the shifting of the icon 6d is completed. That is, (a) through (d) of FIG. 9 illustrate a successive flow of a display screen on which the user operates the icon 6d which is present at a position in a second row of a first column to change a display position of the icon 6d from the position in the second row of the first column to the position in the first row of the second column.

As illustrated in (b) and (c) of FIG. 9, a user can change the display position of the icon 6d so that the icon 6d cut in front of another icon displayed at a higher-priority position (an icon 6b displayed in the first row of the second column in an example of FIG. 9).

The condition determining section 11 finds that, as illustrated in (c) of FIG. 9, no icon is present below a partition line 1 (in a third row and subsequent rows in FIG. 9) (detects the presence of the partition line 1 which is not sandwiched by at least two icons). In a case where the condition determining section 11 finds so, the partition line 1 is caused to be undisplayed (see (d) of FIG. 9).

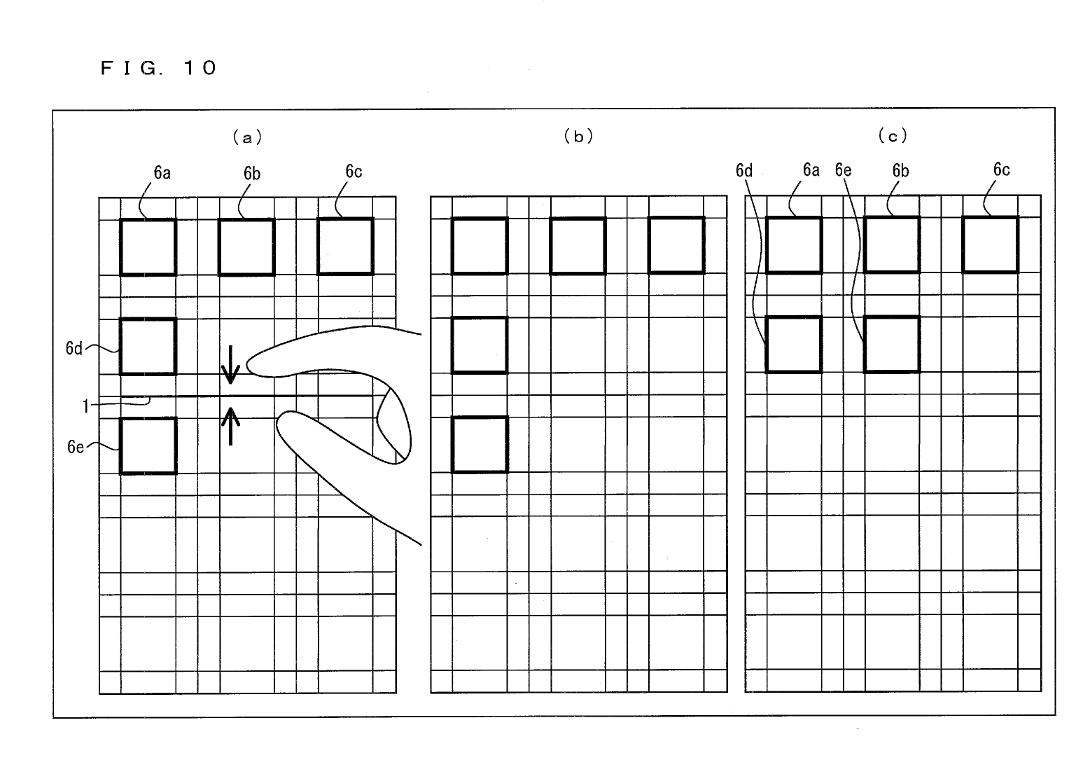

A fifth example operation of the smart phone 100 will be described with reference to FIG. 10. FIG. 10 is a view schematically illustrating the fifth example operation of the smart phone 100 in a case where a user carries out a pinch-in operation with respect to a partition line 1.

(a) of FIG. 10 illustrates an example screen on which the user is carrying out the pinch-in operation with respect to the partition line 1. (b) of FIG. 10 illustrates an example screen immediately after the partition line 1 is undisplayed due to the pinch-in operation. (c) of FIG. 10 illustrates an example screen after an icon 6e is advanced to a position at which an icon is more preferentially displayed because the position becomes vacant.

The condition determining section 11 determines whether or not a user has carried out, with respect to the partition line 1, an operation for moving a plurality of fingers toward a given point present between the plurality of fingers so as to join the plurality of fingers while the plurality of fingers are in touch with the input surface 41 (a so-called pinch-in operation) (see (a) and (b) of FIG. 10). In a case where the condition determining section 11 determines that the pinch-in operation has been carried out with respect to the partition line 1, the partition line non-display section 12b causes the partition line 1 to be undisplayed.

Since the partition line 1 which partitions the icon 6e from icons 6a through 6d (other icons) is caused to be undisplayed (see (b) of FIG. 10), the smart phone 100 rearranges the icons 6a through 6e as icons which are classifiable by use of a partition line (see (c) of FIG. 10). That is, the smart phone 100 advances the icon 6e to a position where an icon is more preferentially displayed so as to display the icon 6e at the position.

A sixth example operation of the smart phone 100 will be described with reference to FIG. 11. FIG. 11 is a view schematically illustrating the sixth example operation of the smart phone 100 in a case where a user carries out a pinch-out operation within a predetermined region (in the region β illustrated in (b) of FIG. 7) which does not include a partition line 1 sandwiched by display positions of at least two icons.

(a) of FIG. 11 illustrates an example screen on which the user is carrying out the pinch-out operation within the predetermined region. (b) of FIG. 11 illustrates an example screen immediately after a partition line 1 is newly displayed due to the pinch-out operation.

The condition determining section 11 determines whether or not a user has carried out, within the predetermined region, an operation for moving a plurality of fingers from a given point present between the plurality of fingers so as to extend a space between the plurality of fingers while the plurality of fingers are in touch with the input surface 41 (a so-called pinch-out operation). In a case where the condition determining section 11 determines that the pinch-out operation has been carried out within the predetermined region, the partition line display section 12a causes a partition line 1 to be displayed, the partition line 1 partitioning icons 6a through 6c from an icon 6d.

[Processes Carried Out by Smart Phone 100]

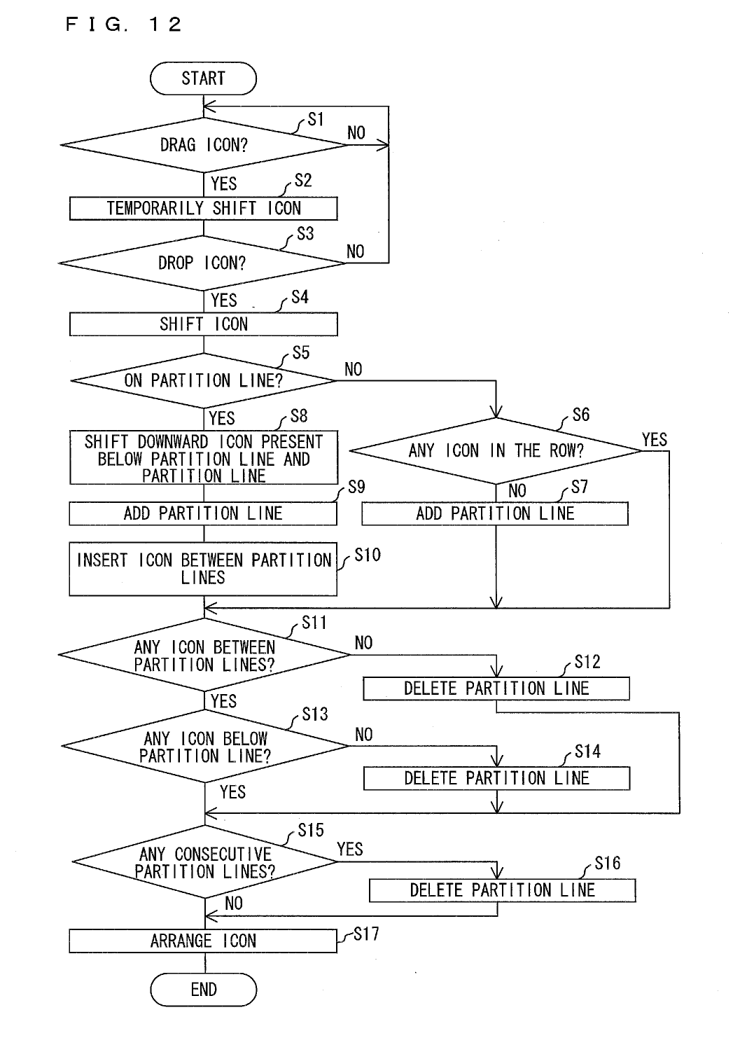

A flow of processes carried out by the smart phone 100 will be described with reference to FIG. 12. FIG. 12 is a flowchart illustrating an example of processes carried out by the smart phone 100. Note that “ . . . step” in parentheses which will be described below represents a step of a control method.

The control section 10 determines whether or not an icon 6 is being dragged (step 1; hereinafter abbreviated as S1). In a case where the control section 10 determines that the icon 6 is being dragged (YES in S1), the control section controls the icon 6 to be temporarily shifted in accordance with the drag (S2). The control section 10 further determines whether or not the icon 6 has been dropped (S3). In a case where the control section 10 determines that the icon 6 has been dropped (YES in S3), the control section 10 controls a first display position of the icon 6 to be changed to a position where the icon 6 has been dropped (S4).

The condition determining section 11 determines whether or not a second display position of the icon 6 to which second display position the first display position of the icon 6 has been changed overlaps with a partition line 1 (S5). In a case where the condition determining section 11 determines that the second display position does not overlap with the partition line 1 (NO in S5), the condition determining section 11 determines whether or not an icon other than the icon 6 is being displayed within a predetermined region that includes the second display position of the icon 6 (S6, determination step). Note that, in the flowchart of FIG. 12, the condition determining section 11 determines whether or not the icon other than the icon 6 whose first display position has been changed is being displayed in a row of the second display position.

In a case where the condition determining section 11 determines that the icon other than the icon 6 is not being displayed (NO in S6), the partition line display section 12a causes a partition line 1 to be displayed between the second display position of the icon 6 and a display position of another icon (S7, classification step). That is, the smart phone 100 displays a screen illustrated in (d) of FIG. 5.

In a case where the condition determining section 11 determines that the second display position of the icon 6 overlaps with the partition line 1 (YES in S5), the control section 10 shifts the partition line 1 and an icon displayed below the partition line 1 (an icon 6e on a screen illustrated in (b) of FIG. 6) downward by one row from a display position of the icon displayed below the partition line 1 (S8). Then, the partition line display section 12a causes another partition line 1 to be additionally displayed (S9). The icon 6 is shifted to a position between the another partition line 1 and the partition line 1 shifted downward in S8 at which position the icon 6 has been dropped (S10). That is, the partition line display section 12a causes the partition line 1 and the another partition line 1 to be displayed on respective opposite sides of the icon 6.

Then, the condition determining section 11 determines whether or not a partition line 1 is being displayed between display positions of at least two icons (S11). In a case where the condition determining section 11 determines that there is a partition line 1 which is not sandwiched by at least two icons (NO in S11), the partition line non-display section 12b causes the partition line 1 to be undisplayed (S12).

In a case where the condition determining section 11 determines that there is no partition line 1 which is not sandwiched by at least two icons (YES in S11), the condition determining section 11 determines whether or not any icon is being displayed below a partition line 1 (whether or not icons and a partition line are in a display state illustrated in (c) of FIG. 9) (S13). In a case where the condition determining section 11 determines that no icon is being displayed below the partition line 1 (NO in S13), the partition line non-display section 12b causes the partition line 1 to be undisplayed (S14).

In a case where the condition determining section 11 determines that an icon is being displayed below the partition line 1 (YES in S13), the condition determining section 11 determines whether or not a plurality of partition lines 1 are being consecutively displayed between a display position of an icon 6 to which display position the icon 6 has been shifted and a display position of an icon other than the icon 6 (S15). In a case where the condition determining section 11 determines that the plurality of partition lines 1 are being consecutively displayed (YES in S15), the partition line non-display section 12b causes at least one of the plurality of partition lines 1 to be undisplayed so that only one of the plurality of partition lines 1 is displayed (S16).

Finally, the control section 10 arranges a display position(s) of an icon(s) (S17). That is, in a case where a position where an icon is more preferentially displayed is vacant due to a user's operation for shifting an icon, the control section 10 advances, to the position where the icon is more preferentially displayed, an icon displayed at a low-priority position so that the icon displayed at the low-priority position is displayed at the position where the icon is more preferentially displayed.

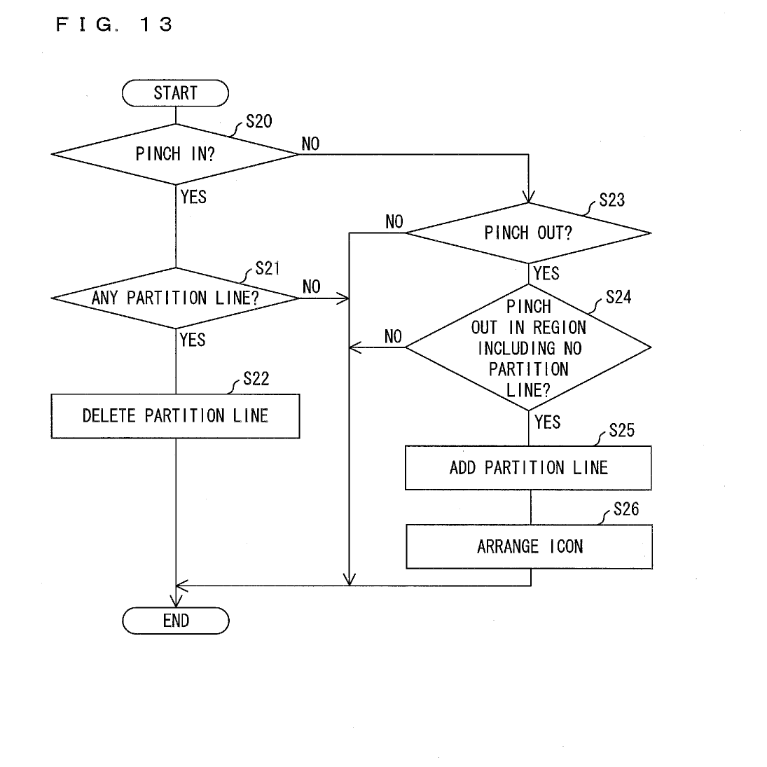

A flow of another processes carried out by the smart phone 100 will be described below with reference to FIG. 13. FIG. 13 is a flowchart illustrating an example of the another processes carried out by the smart phone 100.

The condition determining section 11 determines whether or not a user has carried out a pinch-in operation (S20). In a case where the condition determining section 11 determines that the user has carried out the pinch-in operation (YES in S20), the condition determining section 11 determines whether or not the pinch-in operation has been carried out with respect to a partition line 1 (S21). In a case where the condition determining section 11 determines that the pinch-in operation has been carried out with respect to the partition line 1 (YES in S21), the partition line non-display section 12b causes the partition line 1 to be undisplayed (S22).

In a case where the condition determining section 11 determines that the user has not carried out the pinch-in operation (NO in S20), the condition determining section 11 determines whether or not a user has carried out a pinch-out operation (S23). In a case where the condition determining section 11 determines that the user has carried out the pinch-out operation (YES in S23), the condition determining section 11 determines whether or not the pinch-out operation has been carried out within a predetermined region that does not include a partition line 1 sandwiched by display positions of at least two icons (in a region β illustrated in (b) of FIG. 7) (S24).

In a case where the condition determining section 11 determines that the pinch-out operation has been carried out within the predetermined region (YES in S24), the partition line display section 12a causes a partition line 1 to be displayed within the predetermined region (S25). Finally, the control section 10 arranges a display position(s) of an icon(s) (S26, as with S17).

[Effect Brought about by Smart Phone 100]

The smart phone 100 brings about an effect that it is possible to classify icons displayed on a display screen through a user's simple operation for changing a display position of an icon.

[Combination of Configurations (Technical Means) Included in Each Embodiment]

It should be noted that configurations included in the above-described embodiment are combined with each other as appropriate. That is, all of the configurations explained in the embodiment or a combination of some of the configurations can also be utilized in another embodiment. An embodiment derived from such a combination of the configurations is encompassed in the technical scope of the present invention.

[Software Implementation Example]

Each block of the smart phone 100 may be realized by a hardware such as a logic circuit on an integrated circuit (IC chip) or may be realized by software as executed by a CPU.

In a case where the each block of the smart phone 100 is realized by software as executed by a CPU, the smart phone 100 includes: a CPU that executes instructions of a program that realizes each function; a ROM (Read Only Memory) storing the program; and a RAM that develops the program; and a storage device (storage medium) such as a memory which stores the program and various kinds of data. The object of the present invention can be achieved by mounting to the smart phone 100 a computer-readable storage medium storing a program code of a control program (executable program, intermediate code program, or source program) for the smart phone 100, the control program being software for realizing the foregoing functions, so that the computer (or CPU or MPU) retrieves and executes the program code stored in the storage medium.

The storage medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; a semiconductor memory such as mask ROM, EPROM, EEPROM (Registered Trademark), or flash ROM; or a logic circuit such as a PLD (Programmable logic device) or FPGA (Field Programmable Gate Array).

The smart phone 100 can be arranged to be connectable to a communications network so that the program code is made available to the smart phone 100 via the communications network. The communications network is not limited to a specific one provided that it can transfer the program code to the smart phone 100, and therefore can be, for example, the Internet, Intranet, extranet, LAN, ISDN, VAN, CATV communications network, virtual dedicated network (virtual private network), telephone line network, mobile communications network, or satellite communications network. The transfer medium which constitutes the communications network is not limited to a transfer medium having a specific configuration or specific kinds of transfer medium provided that it can transfer the program code to the smart phone 100, and therefore can be, for example, wired line such as IEEE 1394, USB, electric power line, cable TV line, telephone line, or ADSL (Asymmetric Digital Subscriber Line); or wireless such as infrared radiation (IrDA or remote control), Bluetooth (Registered Trademark), IEEE 802.11 wireless, HDR (High Data Rate), NFC (Near Field Communication), DLNA (Digital Living Network Alliance), mobile telephone network, satellite line, or terrestrial digital network. Note that the present invention can also be implemented by the program code in the form of a computer data signal embedded in a carrier wave which is embodied by electronic transmission.

As such, in the present specification, a “section” does not necessarily mean a physical section but includes a case where a function of each section is realized by software. A function of one section may be realized by two or more physical sections. Alternatively, functions of two or more sections may be realized by one physical section.

[Summary]

An information processing apparatus of Aspect 1 of the present invention is configured to be (1) an information processing apparatus (smart phone 100) including: an input surface capable of detecting a position (coordinate information 4) specified by a user's operation (user's operation 3); a display surface capable of displaying a plurality of icons; a determination section for determining whether or not a predetermined condition is met; and a classification section for, in a case where the determination section determines that the predetermined condition is met, classifying the plurality of icons, display positions of the plurality of icons on the display surface being changeable in accordance with the position specified by the user's operation,

(2) in a case where a first display position of an icon of the plurality of icons is changed, the determination section (condition determining section 11) determining whether or not another icon other than the icon of the plurality of icons is being displayed within a predetermined region that includes a second display position of the icon to which second display position the first display position of the icon has been changed, and

(3) in a case where the determination section determines that the another icon is not being displayed within the predetermined region, the classification section (partition line display section 12a) causing a partition line to be displayed between the second display position of the icon and a display position of another icon of the plurality of icons.

In order to attain the object, a method, of Aspect 1 of the present invention, of controlling an information processing apparatus is configured to be (1) a method of controlling an information processing apparatus capable of changing, in accordance with a position specified by a user's operation, display positions of a plurality of icons on a display surface capable of displaying the plurality of icons, the method including the steps of: (a) determining whether or not a predetermined condition is met; and (b), in a case where it is determined in the step (a) that the predetermined condition is met, classifying the plurality of icons,

(2) in a case where a first display position of an icon of the plurality of icons is changed, it being determined in the step (a) (S6) whether or not another icon other than the icon of the plurality of icons is being displayed within a predetermined region that includes a second display position of the icon to which second display position the first display position of the icon has been changed, and

(3) in a case where it is determined in the step (a) that the another icon is not being displayed within the predetermined region, in the step (b) (S7), a partition line being caused to be displayed between the second display position of the icon and a display position of another icon of the plurality of icons.

According to the above configurations (1) through (3), the information processing apparatus of and the method of controlling the information processing apparatus of Aspect 1 of the present invention are capable of changing display positions of a plurality of icons in accordance with a position specified by a user. Note here that the information processing apparatus etc. determines whether or not a predetermined condition is met, and in a case where the information processing apparatus etc. determines that the predetermined condition is met, the information processing apparatus etc. is capable of classifying a plurality of icons.

The information processing apparatus etc. determines whether or not the predetermined condition is met, in a case where a first display position of an icon is changed, the case acting as a trigger. It should be noted here that the predetermined condition means whether or not another icon other than the icon is being displayed within a predetermined region including a second display position of the icon to which second display position the first display position has been changed.

In a case where the information processing apparatus etc. determines that the another icon other than the icon is not being displayed within the predetermined region, the information processing apparatus etc. displays a partition line between the second display position of the icon and a display position of another icon so as to classify a plurality of icons.

As such, according to the information processing apparatus of and the method of controlling the information processing apparatus of Aspect 1 of the present invention, a user can classify icons displayed on a display screen by carrying out a simple operation for changing a display position of an icon.

The information processing apparatus of Aspect 1 of the present invention may further be configured to be an information processing apparatus of Aspect 2 of the present invention wherein

(1) the determination section further determines whether or not the first display position of the icon has been changed so that the icon overlaps with a partition line,

(2) in a case where the determination section determines that the first display position of the icon has been changed so that the icon overlaps with the partition line, the classification section causes partition lines to be displayed on respective opposite sides of the icon.

According to the above configurations (1) and (2), the information processing apparatus determines whether or not the first display position of the icon has been changed so that the icon overlaps with a partition line. In a case where the information processing apparatus determines that the first display position of the icon has been changed so that the icon overlaps with the partition line, the information processing apparatus displays partition lines on respective opposite sides of the icon.

Therefore, the information processing apparatus of Aspect 2 of the present invention can add a partition line which partitions only an icon from another icon in response to a user's simple operation for dropping the icon on a partition line.

The information processing apparatus of Aspect 1 or 2 of the present invention may further be configured to be an information processing apparatus of Aspect 3 of the present invention wherein

(1) in the case where the first display position of the icon is changed, the determination section further determines whether or not a partition line is being displayed between display positions of at least two icons of the plurality of icons, and

(2) the information processing apparatus further includes a first non-display section (partition line non-display section 12b) for, in a case where the determination section determines that the partition line is not being displayed between the display positions of the at least two icons, causing the partition line to be undisplayed.

According to the above configurations (1) and (2), in the case where the first display position of the icon is changed, the information processing apparatus determines whether or not a partition line is being displayed between display positions of at least two icons of the plurality of icons. In a case where the information processing apparatus determines that the partition line is not being displayed between the display positions of the at least two icons, the information processing apparatus is capable of undisplaying the partition line.

Therefore, the information processing apparatus of Aspect 3 of the present invention can cause an unnecessary partition line to be undisplayed in response to a user's simple operation for changing a display position of an icon, and can more effectively classify icons displayed on a display screen.

The information processing apparatus of any one of Aspects 1 through 3 of the present invention may further be configured to be an information processing apparatus of Aspect 4 of the present invention wherein

(1) in the case where the first display position of the icon is changed, the determination section further determines whether or not a plurality of partition lines are being consecutively displayed between the second display position of the icon and a display position of another icon of the plurality of icons, and

(2) the information processing apparatus further includes a second non-display section (partition line non-display section 12b) for, in a case where the determination section determines that the plurality of partition lines are being consecutively displayed between the second display position of the icon and the display position of the another icon of the plurality of icons, causing at least one of the plurality of partition lines to be undisplayed so that only one of the plurality of partition lines is displayed.

According to the above configurations (1) and (2), in the case where the first display position of the icon is changed, the information processing apparatus determines whether or not a plurality of partition lines are being consecutively displayed between the second display position of the icon and a display position of another icon of the plurality of icons. In a case where the information processing apparatus determines that the plurality of partition lines are being consecutively displayed, the information processing apparatus undisplays at least one of the plurality of partition lines so that only one of the plurality of partition lines is displayed.

Therefore, the information processing apparatus of Aspect 4 of the present invention can cause an unnecessary partition line to be undisplayed in response to a user's simple operation for changing a display position of an icon, and can more effectively classify icons displayed on a display screen.

The information processing apparatus of any one of Aspects 1 through 4 of the present invention may further be configured to be an information processing apparatus of Aspect 5 of the present invention wherein

(1) in a case where the first display position of the icon is not changed, the determination section determines whether or not a user has carried out, with respect to a partition line, a pinch-in operation for shifting a plurality of positions toward a given point present between the plurality of positions so as to join the plurality of positions while the plurality of positions are being specified on the input surface, and

(2) the information processing apparatus further includes a third non-display section (partition line non-display section 12b) for, in a case where the determination section determines that the pinch-in operation has been carried out, causing the partition line to be undisplayed.

According to the above configurations (1) and (2), in a case where the information processing apparatus determines that a user has carried out the pinch-in operation with respect to a partition line, the information processing apparatus undisplays the partition line.

Therefore, the information processing apparatus of Aspect 5 of the present invention can cause an unnecessary partition line to be undisplayed and can more effectively classify icons displayed on a display screen, in response to a user's simple operation, i.e., the pinch-in operation.

The information processing apparatus of any one of Aspects 1 through 5 of the present invention may further be configured to be an information processing apparatus of Aspect 6 of the present invention wherein

(1) in a case where the first display position of the icon is not changed, the determination section determines whether or not a user has carried out, within a predetermined region that does not include a partition line sandwiched by display positions of at least two icons of the plurality of icons, a pinch-out operation for shifting a plurality of positions from a given point present between the plurality of positions so as to extend a space between the plurality of positions while the plurality of positions are being specified on the input surface,

(2) in a case where the determination section determines that the pinch-out operation has been carried out, the classification section causes a partition line to be displayed within the predetermined region.

According to the above configurations (1) and (2), in a case where the information processing apparatus determines that a user has carried out the pinch-out operation within the predetermined region, the information processing apparatus displays a partition line within the predetermined region.

Therefore, the information processing apparatus of Aspect 6 of the present invention can newly add a partition line and can more effectively classify icons displayed on a display screen, in response to a user's simple operation, i.e., the pinch-out operation.

Note that the information processing apparatus may be realized by a computer. In this case, the scope of the present invention encompasses (i) a control program for causing the computer to function as each of the sections of the information processing apparatus so that the information processing apparatus is realized by the computer, and (ii) a computer-readable storage medium in which the control program is stored.

### INDUSTRIAL APPLICABILITY

The present invention is applicable to an electronic device which (i) has an input surface capable of detecting a position specified by a user's operation, and a display surface capable of displaying a plurality of icons and (ii) is capable of changing a display position of an icon on the display surface in accordance with the position specified by the user's operation. Specifically, the present invention is suitably applicable to, for example, a smart phone, a personal computer or a tablet-type information terminal.

### REFERENCE SIGNS LIST

1: Partition line (partition line)
3: User's operation (user's operation)
4: coordinate information (specified position)
6a: icon (icon)
6b: icon (icon)
6c: icon (icon)
6d: icon (icon)
6e: icon (icon)
11: condition determining section (determination section)
12a: partition line display section (classification section)
12b: partition line non-display section (first non-display section, second non-display section, third non-display section)
41: input surface (input surface)
72: display surface (display surface)
100: smart phone (information processing apparatus)

1. An information processing apparatus, comprising:
an input surface capable of detecting a position specified by a user's operation;
a display surface capable of displaying a plurality of icons;
a determination section for determining whether or not a predetermined condition is met; and
a classification section for, in a case where the determination section determines that the predetermined condition is met, classifying the plurality of icons,
display positions of the plurality of icons on the display surface being changeable in accordance with the position specified by the user's operation,
in a case where a first display position of an icon of the plurality of icons is changed, the determination section determining whether or not another icon other than the icon of the plurality of icons is being displayed within a predetermined region that includes a second display position of the icon to which second display position the first display position of the icon has been changed, and
in a case where the determination section determines that the another icon is not being displayed within the predetermined region, the classification section causing a partition line to be displayed between the second display position of the icon and a display position of another icon of the plurality of icons.

2. The information processing apparatus as set forth in claim 1, wherein the determination section further determines whether or not the first display position of the icon has been changed so that the icon overlaps with a partition line,
in a case where the determination section determines that the first display position of the icon has been changed so that the icon overlaps with the partition line, the classification section causes partition lines to be displayed on respective opposite sides of the icon.

3. The information processing apparatus as set forth in claim 1, wherein, in the case where the first display position of the icon is changed, the determination section further determines whether or not a partition line is being displayed between display positions of at least two icons of the plurality of icons, and
the information processing apparatus further comprises a first non-display section for, in a case where the determination section determines that the partition line is not being displayed between the display positions of the at least two icons, causing the partition line to be undisplayed.

4. The information processing apparatus as set forth in claim 1, wherein, in the case where the first display position of the icon is changed, the determination section further determines whether or not a plurality of partition lines are being consecutively displayed between the second display position of the icon and a display position of another icon of the plurality of icons, and
the information processing apparatus further comprises a second non-display section for, in a case where the determination section determines that the plurality of partition lines are being consecutively displayed between the second display position of the icon and the display position of the another icon of the plurality of icons, causing at least one of the plurality of partition lines to be undisplayed so that only one of the plurality of partition lines is displayed.

5. The information processing apparatus as set forth in claim 1, wherein, in a case where the first display position of the icon is not changed, the determination section determines whether or not a user has carried out, with respect to a partition line, a pinch-in operation for shifting a plurality of positions toward a given point present between the plurality of positions so as to join the plurality of positions while the plurality of positions are being specified on the input surface, and
the information processing apparatus further comprises a third non-display section for, in a case where the determination section determines that the pinch-in operation has been carried out, causing the partition line to be undisplayed.

6. The information processing apparatus as set forth in claim 1, wherein, in a case where the first display position of the icon is not changed, the determination section determines whether or not a user has carried out, within a predetermined region that does not include a partition line sandwiched by display positions of at least two icons of the plurality of icons, a pinch-out operation for shifting a plurality of positions from a given point present between the plurality of positions so as to extend a space between the plurality of positions while the plurality of positions are being specified on the input surface,
in a case where the determination section determines that the pinch-out operation has been carried out, the classification section causes a partition line to be displayed within the predetermined region.

7. A method of controlling an information processing apparatus capable of changing, in accordance with a position specified by a user's operation, display positions of a plurality of icons on a display surface capable of displaying the plurality of icons,
the method comprising the steps of:
(a) determining whether or not a predetermined condition is met; and
(b), in a case where it is determined in the step (a) that the predetermined condition is met, classifying the plurality of icons,
in a case where a first display position of an icon of the plurality of icons is changed, it being determined in the step (a) whether or not another icon other than the icon of the plurality of icons is being displayed within a predetermined region that includes a second display position of the icon to which second display position the first display position of the icon has been changed, and
in a case where it is determined in the step (a) that the another icon is not being displayed within the predetermined region, in the step (b), a partition line being caused to be displayed between the second display position of the icon and a display position of another icon of the plurality of icons.

8. (canceled)

9. A non-transitory computer-readable storage medium storing thereon a control program for causing the information processing apparatus as set forth in claim 1 to operate, the control program causing a computer to function as each of the sections.
